(19) United States
(12) Patent Application Publication
(10) Pub. No.: US 2007/0184419 A1
(43) Pub. Date: Aug. 9, 2007

(54) Apparatus and Method for Teaching Multiplication and Division

(76) Inventor: Jennifer L. Tuttle, Chesterfield Township, MI (US)

Correspondence Address: GREGORY T. ZALECKI, 12900 HALL ROAD, SUITE 400, STERLING HEIGHTS, MI, 48313, US

(21) Appl. No.: 11/461,363

(22) Filed: Jul. 31, 2006

Related U.S. Application Data
(60) Provisional application No. 60/771,331, filed on Feb. 9, 2006.

(51) Int. Cl. G09B 19/02

(52) U.S. Cl. 434/188

(57) ABSTRACT

An apparatus for teaching mathematics is comprised of a visual display having rows of integers sequentially presented from left to right and top to bottom. A plurality of the integers are highlighted as a pattern such that they each have one common factor and each highlighted integer is a multiple of that factor. To teach multiplication of a multiplier by an upper limited series of multiplicands, a value of the multiplier to be taught is determined. The student is taught to skip count the multiplier for a range of multiplicands within the series. The range is progressively increased to the upper limit. A strategy for multiplication comprising determining a product by skip counting by the multiplier for a number of iterations equal to the multiplicand is taught. The skip counting process is visually pointed out on the apparatus. The skip counting procedure can also be used to teach division.

### RELATED APPLICATIONS

This application is based upon provisional application Ser. No. 60/771,331 filed on Feb. 9, 2006, which is incorporated by reference.

### BACKGROUND

Mathematics is a subject of significant importance. It lies at the foundation of most public school general educational systems. While mathematics comes easily to some students, it is a substantial struggle for others. As a result, teachers are challenged to find and develop more and better methods for teaching mathematics.

Multiplication and division are basic mathematical operations which must be learned by any student intending to master mathematics. Many students are not mentally able to absorb the principles of multiplication and division before the age of 11 or 12. Traditionally, such students are initially taught multiplication by requiring them to memorize multiplication tables. For example, students are required to know the following facts contained within multiplication tables: 3×1=3, 3×2=6, 3×3=9, 3×4=12, 3×5=15, 3×6=18, 3×7=21, 3×8=24, 3×9=27 and 3×10=30. In this table the multiplier is 3 and the multiplicand ranges from 1 to 10. Multiplication students are sometimes required to memorize multiplication tables for multipliers ranging from 1 to 10 and for multiplicands ranging from 1 to 10. Often, the range for both multipliers and multiplicands is 1 to 12. As an alternative, the student may be taught to multiply by mentally counting.

Learning multiplication by memorization or mental counting is a difficult and tedious task for many students. There is a need for a better method. The better method should apply the process of skip counting. Skip counting is repetitive counting by a number other than 1. For example, 2, 4, 6, 8, 10 is skip counting by 2. 5, 10, 15, 20, 25 is skip counting by 5. 7, 14, 21, 28, 35 is skip counting by 7. Once the student obtains mastery of skip counting, the skip counting procedure can be used to more easily and effectively learn multiplication and division.

It is well known that learning can be made more efficient and effective by employing more than one sense. The teaching of multiplication and division can be made more efficient and more effective by stimulating the student's visual, auditory and tactile senses. There is a need for a method and apparatus for teaching multiplication and division having the following features. It would facilitate quicker learning. Learning would be more enjoyable for the student. The student would obtain a better mastery of the fundamentals of multiplication and division. The student would be able to learn multiplication and division at a younger age. The student would be better able to visualize the multiplication process.

These needs are met by the invention described herein.

### SUMMARY

An object of this invention is to provide a system for teaching multiplication and division. This system may be shared with others via video/DVD, CD, software, internet, books, posters, magnetic boards, and any other means possible.

The first step in this system is to teach students to skip count. Skip counting is counting by 1's, 2's, 3's, 4's, . . . For example, counting by 3's is 3, 6, 9, 12, . . .

Skip counting is taught through a call and echo approach I call, “I count, you count.” The teacher begins by motioning hands to herself stating “I count” and chanting a number pattern, then motioning hands to students stating “you count” and students shall repeat the same number pattern. The teacher groups numbers sequentially in groups of 3's or 4's. For example:

I Count: 4, 8, 12, 16

You Count: 4, 8, 12, 16

I count: 20, 24, 28, 32

You Count: 20, 24, 28, 32

I count: 36, 40, 44, 48

You count: 36, 40, 44, 48

The teacher then continues with the call and echo method by extending the number pattern.

I count: 4, 8, 12, 16, 20, 24, 28, 32

You Count: 4, 8, 12, 16, 20, 24, 28, 32

I Count: 36, 40, 44, 48

You Count: 36, 40, 44, 48

The teacher ends the call and echo methodology by chanting the entire number pattern:

I count: 4, 8, 12, 16, 20, 24, 28, 32, 36, 40, 44, 48

You Count: 4, 8, 12, 16, 20, 24, 28, 32, 36, 40, 44, 48

The teacher repeats or changes the groupings of the numbers as necessary to meet the needs of the students in her class.

The teacher uses a variety of teaching modalities including, but not limited to, language arts, music, movement, chanting, rhythmic patterns, and visual number patterns to extend the teaching of skip counting through games and activities. The activities can be completed in any order deemed necessary by the instructor.

The next step is to introduce counting songs through the same call and echo, “I sing, you sing,” approach. The teacher may also introduce kinesthetic movements and rhythm patterns to do while counting and/or singing.

The teacher introduces number chart posters and magnetic boards giving students visual number patterns to utilize while counting and participating in games and activities.

After the students have obtained mastery of skip counting, the teacher teaches the students multiplication and division strategy. The strategy for multiplication is to skip count by the multiplicand, as many times as the multiplier (or vice versa) to obtain the product.

For example, 3×4=?

Strategy: Skip count by 3's four times.

3, 6, 9, 12 . . .

The product is 12.

The division strategy is to skip count by the divisor until reaching the dividend to obtain the quotient.

For example, 10/2=?

Strategy: Skip count by 2's until reaching 10.

Count how many times you are skip counting.

2, 4, 6, 8, 10

You counted by 2's five times.

The quotient is 5.

Finally, the students are assessed on their multiplication and division facts using various assessment methods.

The method for teaching multiplication and division is best implemented by using an apparatus for teaching mathematics to teach skip counting. The apparatus is comprised of a visual display. The visual display may be a poster board or a magnetic board. The visual display displays rows of integers. The integers are sequentially presented from left to right and from top to bottom. Preferably, the rightmost integer of each row of integers is a multiple of 10. A plurality of the integers are highlighted as a pattern. The highlighted integers each have one common factor and each highlighted integer is a multiple of that factor.

A single visual display may be adapted to teach skip counting by a specific multiplier. For example, a visual display may be adapted to teach skip counting by a multiplier of 3 by highlighting the numbers on the display consisting of the numbers 3, 6, 9, 12, 15, 18, 21, 24, 27, 30, 33 and 36. Preferably, a single visual display is adapted to be useful for teaching skip counting by a plurality of multipliers. Such a board could be used to teach skip counting by any multiplier, including multipliers between 1 and 12.

In order to adapt a single visual display to be useful for teaching skip counting by a plurality of multipliers the integers on the display itself are not highlighted. The integers are highlighted into a skip counting pattern desired by the teacher by placing chips over selected integers to form a desired highlighted pattern. The chips are releasably attachable to the display. Each chip has a transparent colored face for highlighting an integer covered by the chip. Preferably, the visual display and each chip are adapted such that each chip is magnetically releasably attachable to the display. Such a chip is magnetically attracted to the visual display.

Other methods for releasably attaching a chip to the visual display may also be used. Hook and loop fasteners may be used on the chips and the visual display. Each hook and loop fastener should be a strip of material with a surface of minute hooks or a surface of uncut pile. One surface should be a hook surface and the other surface should be a pile surface. Such fasteners are currently being sold under the tradename VELCRO. VELCRO is a synthetic material sold in ribbon, sheet, or piece goods form. The material has complemental parts which adhere to each other when pressed together and is adapted for use as a closure fastener, or button for closing garments, curtains, or the like.

### DRAWINGS

These and other features, aspects, and advantages of the present invention will become better understood with regard to the following description, appended claims, and accompanying drawings where:

FIG. 1 is a plan of view of a visual display of an apparatus for teaching mathematics without highlighted integers.

FIG. 2 is a plan view of a plurality of chips for forming highlighted patterns on the apparatus of FIG. 1.

FIG. 3 is a plan view of a visual display of an apparatus for teaching mathematics adapted to teach skip counting by 2's.

FIG. 4 is a plan view of a visual display of an apparatus for teaching mathematics adapted to teach skip counting by 3's.

FIG. 5 is a side elevation view of an apparatus for teaching mathematics comprised of a visual display covered by a highlighted transparent overlay for highlighting integers on the display as a pattern.

FIG. 6 is an exploded perspective view of the apparatus for teaching mathematics comprised of a visual display covered by a highlighted transparent overlay of FIG. 5.

FIG. 7 is a perspective view of the apparatus for teaching mathematics comprised of a visual display covered by a highlighted transparent overlay of FIG. 6, wherein the overlay is secured to the visual display.

FIG. 8 is a top plan view of a magnetically releasably attachable chip.

FIG. 9 is a sectional elevation view of the magnetically releasably attachable chip of FIG. 8.

FIG. 10 is a perspective view of the magnetically releasably attachable chip of FIG. 8.

### DESCRIPTION

An apparatus for teaching mathematics 20 is comprised of a visual display 22. The visual display 22 may be a poster board. Preferably, it is a board with magnetic properties. The term board with magnetic properties includes boards which themselves are magnetic, as well as metallic boards which are attracted to magnets. A magnetic board may be quickly and easily adapted to teach skip counting by many different multipliers.

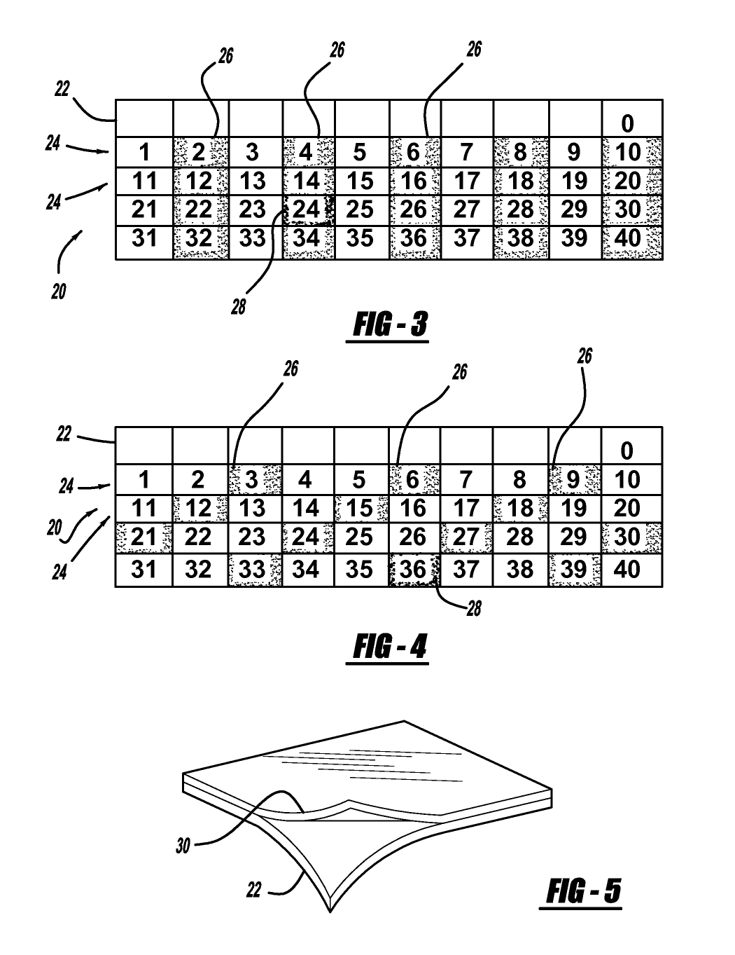

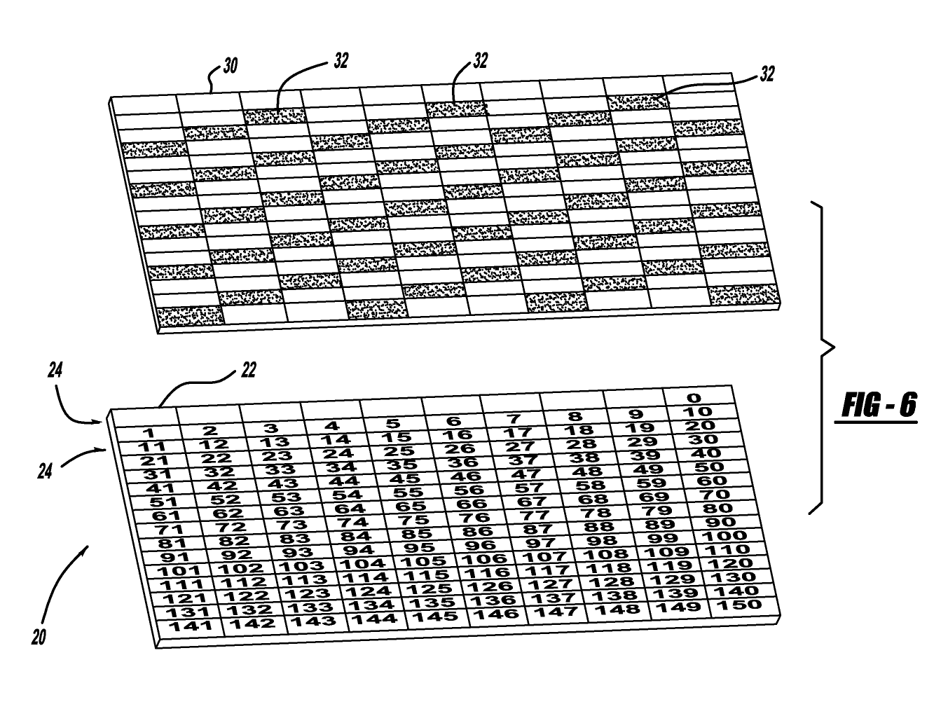

The simplest type of visual display 22 is shown in FIG. 3 and FIG. 4. There, the visual displays 22 are poster boards. Each visual display 22 contains rows of integers 24. The integers are sequentially presented from left to right and from top to bottom. The last rightmost integer of each row of integers 24 should be a multiple of 10. A plurality of integers are highlighted as a pattern. The highlighted integers 26 each have one common factor such that each highlighted integer 26 is a multiple of the factor. For example, if the common factor is 4, the highlighted integers would be 4, 8, 12, 16, 20, 24, 28, 32, 36, 40, 44 and 48.

The pattern of multiples of 4 given in this example is a sequence of products. In that sequence the multiplicand is 4. The multiplier progresses sequentially from 1 to 12. The 12^{th} product or highlighted number is 48. I call this the “magic number” 28. The “magic number” 28 is consistent with current teaching standards for teaching children multiplication. Those standards typically require children to learn how to multiply a given multiplicand by multipliers ranging between 1 and 12. Thus, the 12^{th} product or highlighted number is called the “magic number.”

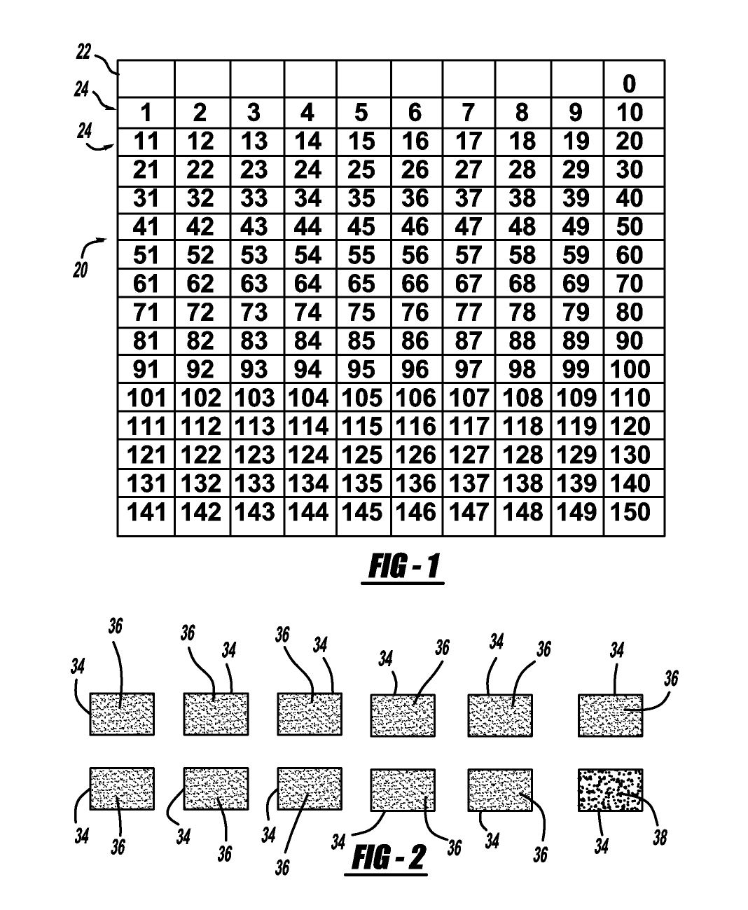

The preferred visual display 22 is shown in FIG. 1. That visual display 22 contains 15 rows (not counting the first row which contains the single integer 0) of integers 24. This will allow the teaching of multiplication for multiplicands between 1 and 12 and multipliers between 1 and 12. The visual display 22 of FIG. 1 does not itself contain any highlighted integers. A plurality of chips 34 are used to form the pattern of highlighted integers 26. Each chip 34 is releasably attachable to the display 22. The chips 34 are adapted to be securely attached over an integer on the display 22 such that the integer is highlighted. Because the chips 34 are releasably attachable to the display 22, they may be easily and quickly removed and repositioned on the display 22. Hook and pile fasteners may be used to make the chips 34 releasably attachable to the visual display 22, as previously indicated. The term releasably attachable chip 34 also includes highlighter tape sized to fit over an integer on the visual display 22. Highlighter tape is releasably attachable to a board surface. It is also transparent and colored. Thus, highlighter tape may be quickly and easily adapted to highlight an integer on a visual display 22.

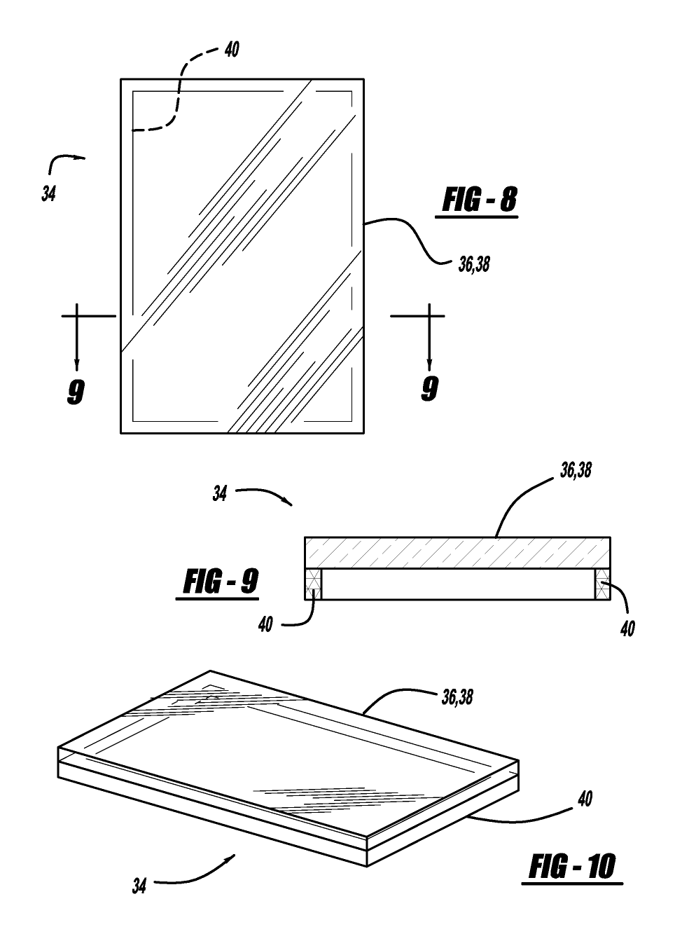

Preferably, however, each chip 34 is magnetically releasably attachable to the display 22. A chip 34 which is magnetically releasably attachable to the display 22 is shown in FIGS. 8-10. The chip 34 has a transparent face 36. The transparent face 36 should be colored to enhance the highlighting of an integer over which it is placed. One chip 34 should have a transparent face 36 with a contrasting color 38. The contrasting color 38 is used on a chip intended to highlight the “magic number.” The contrasting color 38 contrasts with the colors of the other chips 34. A generic set of chips 34 is shown in FIG. 2. The bottom right chip 34 there has the contrasting color 38. A magnetically releasably attachable chip 34 has a magnetic base 40. The transparent face 36 is attached to the magnetic base 40. The magnetic base 40 and the visual display 22 are fabricated from materials which magnetically attract.

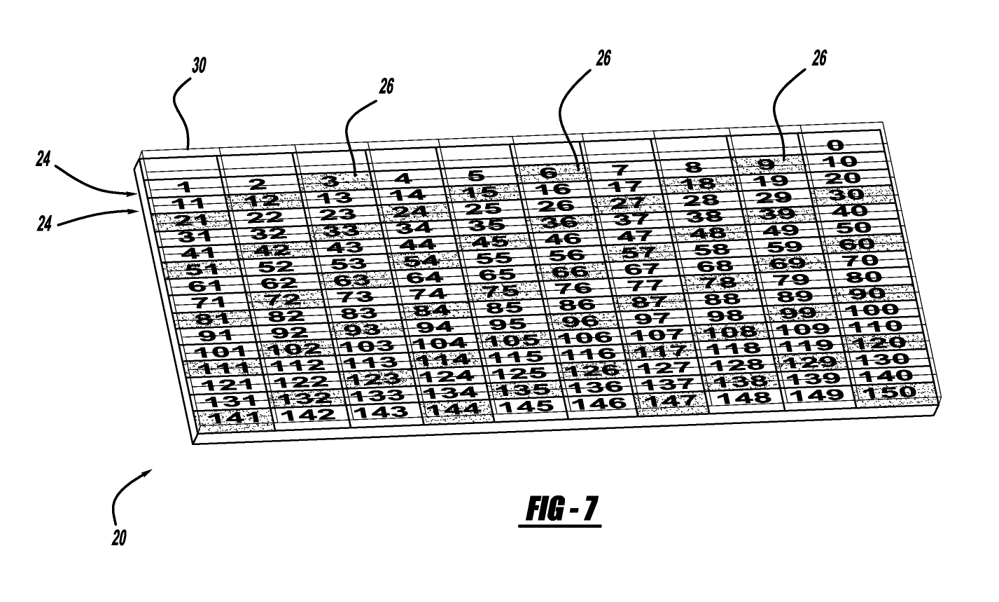

An alternative apparatus for teaching mathematics 20 is shown in FIG. 6 and FIG. 7. That embodiment is comprised of a visual display board 22 and an overlay 30. The display board 22 contains rows of integers 24 which are sequentially presented from left to right and from top to bottom, as in the visual display 22 of FIG. 1. The overlay 30 is adapted to be releasably attachable to the display board 22. This can be accomplished by using a flexible plastic sheet which sticks to the display board 22 as the overlay 30, or by securing the overlay 30 to the display board 22 similar to the way that pages are attached to a flip chart. For example, the overlay 30 could be attached to the display board 22 by a removable clamp or by a more permanent type of a fastener, such as a series of staples. The overlay 30 has highlighted sections 32. The highlighted sections 32 are adapted to transparently highlight integers on the display board 22 which they cover. The highlighted sections 32 are adapted and positioned on the overlay 30 to highlight a plurality of the integers on the display board 22 as a pattern such that the highlighted integers each have one common factor and each highlighted integer is a multiple of that factor.

This invention includes a method for teaching multiplication of a multiplier by an upper limited series of multiplicands to a student. In 8×32, the multiplicand is 32. The multiplier is 8.

The method for teaching multiplication can be most easily explained by an example. It is desired to teach a student the following multiplication fundamentals: 4×1=4, 4×2=8, 4×3=12, 4×4=16, 4×5=20, 4×6=24, 4×7=28, 4×8=32, 4×9=36, 4×10=40, 4×11=44 and 4×12=48. Here, the multiplier is 4 for each mathematical operation. The multiplicands iteratively progress from 1 to 12 through this series of mathematical operations. In this example the multiplicands are upper limited at 12. In other words, it is intended to teach the student how to multiply the number 4 by each number between 1 and 12, inclusively. The final operation, 4×12=48, yields the “magic number” because the multiplicand is 12.

In order to teach multiplication of a multiplier by an upper limited series of multiplicands to a student a value of the multiplier to be taught to the student is determined. In the example this number is 4. The range and the upper limit of the upper limited series of multiplicands to be taught to the student is determined. In the example the upper limit of the upper limited series of multiplicands is 12. The range of the series of multiplicands is 1 through 12.

The student is then taught to skip count the multiplier for a range of multiplicands within the series. The range has an upper limit which is less than the upper limit of the series of multiplicands to be taught. In the example, the upper limit of the series of multiplicands to be taught is 12 and, therefore, a range of multiplicands having an upper limit less than 12 is selected. If the range of multiplicands having an upper limit which is less than the upper limit of the series of multiplicands to be taught is 1 through 4, then skip counting with the operations 4×1, 4×2, 4×3 and 4×4 is initially taught.

The lesser upper limit of the series of multiplicands for which the student is taught to skip count is progressively increased to the upper limit of the series of upper limited multiplicands to be taught, as the student learns to skip count the multiplier for increasing ranges of multiplicands. In other words, in the example, the skip counting operations are progressively increased from 4×1 to 4×12.

The student is taught a strategy for multiplication. The strategy comprises determining a product by skip counting by the multiplier for a number of iterations equal to the multiplicand. Thus, if the student desires to perform the multiplication operation 4×8, the student would determine the product of that operation by skip counting the number 4 eight times, yielding a product of 32. Alternatively, the strategy could comprise determining a product by skip counting by the multiplicand for a number of iterations equal to the multiplier.

The step of teaching a student to skip count is as described in the summary section. Preferably, the step of teaching a student to skip count is comprised of a call and echo chant wherein the teacher chants the skip count for the range of multiplicands and the student echoes the same chant to the teacher, as also described in the summary section.

The preferred method for teaching multiplication of a multiplier by an upper limited series of multiplicands to a student employs the use of the apparatus for teaching mathematics 20 which was described above. After the apparatus 20 is selected a pattern of highlighted integers 26 is set on the apparatus 20. The pattern of highlighted integers 26 is set to correspond to the skip count of the multiplier for a range of multiplicands for which skip counting is being taught. In the example above, using a multiplier of 4, the pattern of highlighted integers 26 would be 4, 8, 12, 16, 20, 24, 28, 32, 36, 40 and 48. Subsets of these highlighted integers 26 may be used when the range of multiplicands being taught is less than the full upper limited range of multiplicands. The pattern of highlighted integers 26 can be set in a number of ways, depending upon the version of the apparatus for teaching mathematics 20 which is being used. A visual display 22 having a predefined set of highlighted integers 26, as shown in FIG. 3 and FIG. 4, may be selected. The pattern of highlighted integers 26 may be set by placing chips 34 over the integers in the pattern. Also, the pattern can be set by selecting a transparent overlay 30 having highlighted sections 32 which correspond to the pattern and securing that overlay 30 to a display board 22, as shown in FIG. 7. In each instance the apparatus 20 is selected and adapted such that the pattern of the highlighted integers 26 on the apparatus 20 corresponds to the skip count of the multiplier for a range of multiplicands for which skip counting is being taught.

It should be clear that the step of teaching a student to skip count a multiplier for a range of multiplicands can be easily modified to teaching a student to skip count a multiplicand for a range of multipliers. Both steps involve teaching a student to skip count a first factor by an upper limited series of second factors. Both steps are equally effective when teaching a student to skip count because multiplying a first factor by a second factor yields the same product as multiplying the second factor by the first factor.

The method for teaching multiplication of a multiplier by an upper limited series of multiplicands to a student can be used to teach division to a student. A value of a first factor is determined. The range and the upper limit of an upper limited series of second factors to be taught to the student is determined. The student is taught to skip count the first factor for a range of second factors within the series. The range has an upper limit which is less than the upper limit of the series of second factors to be taught. The lesser upper limit of the series of second factors for which the student is taught to skip count is progressively increased to the upper limit of the series of upper limited second factors to be taught, as the student learns to skip count the first factor for increasing ranges of second factors. The student is taught a strategy for division. One strategy for division comprises determining a quotient by skip counting by the divisor until the dividend is reached. The quotient is the number of times that the divisor has been skip counted. Another strategy for division comprises determining a divisor by skip counting the quotient until the dividend is reached. The divisor is the number of times that the quotient has been skip counted.

Although the invention has been shown and described with reference to certain preferred embodiments and methods, those skilled in the art undoubtedly will find alternative embodiments and methods obvious after reading this disclosure. With this in mind, the following claims are intended to define the scope of protection to be afforded the inventor, and those claims shall be deemed to include equivalent constructions insofar as they do not depart from the spirit and scope of the present invention.

What is claimed is:

1. An apparatus for teaching mathematics comprising:
(a) a visual display;
(b) rows of integers on the visual display, wherein the integers are sequentially presented from left to right and from top to bottom; and
(c) wherein a plurality of the integers are highlighted as a pattern, said highlighted integers each having one common factor such that each highlighted integer is a multiple of the factor.

2. The apparatus for teaching mathematics of claim 1, further comprising: a plurality of chips forming the highlighted pattern, each said chip being releasably attachable to the display, and each said chip having a transparent face for highlighting an integer covered by the chip.

3. The apparatus for teaching mathematics of claim 2, wherein the visual display and each chip are adapted such that each chip is magnetically releasably attachable to the display.

4. The apparatus for teaching mathematics of claim 1, wherein the display is a poster board and wherein the last rightmost integer of each row of integers is a multiple of 10.

5. The apparatus for teaching mathematics of claim 1, further comprising a transparent overlay adapted to be releasably attachable to a board portion of the visual display, said overlay having highlighted sections adapted to transparently highlight integers on the display, said highlighted sections being adapted and positioned on the overlay to highlight the plurality of highlighted integers, wherein said overlay covers the board portion to highlight the integers.

6. The apparatus for teaching mathematics of claim 1, wherein one of the highlighted integers is highlighted such that it contrasts with the other highlighted integers.

7. A method for teaching multiplication of a multiplier by an upper limited series of multiplicands to a student, said method comprising:
(a) determining a value of the multiplier to be taught to the student;
(b) determining the range and the upper limit of the upper limited series of multiplicands to be taught to the student;
(c) teaching the student to skip count the multiplier for a range of multiplicands within the series, said range having an upper limit which is less than the upper limit of the series of multiplicands to be taught;
(d) progressively increasing said lesser upper limit of the series of multiplicands for which the student is taught to skip count to the upper limit of the series of upper limited multiplicands to be taught, as the student learns to skip count the multiplier for increasing ranges of multiplicands; and
(e) teaching the student a strategy for multiplication comprising determining a product by skip counting by the multiplier for a number of iterations equal to the multiplicand.

8. The method for teaching multiplication of a multiplier by an upper limited series of multiplicands to a student of claim 7, wherein the step of teaching the student to skip count the multiplier for a range of multiplicands within the series, said range having an upper limit which is less than the upper limit of the series of multiplicands to be taught is comprised of a call and echo chant, wherein the teacher chants the skip count for the range of multiplicands and the student echoes the same chant to the teacher.

9. The method for teaching multiplication of a multiplier by an upper limited series of multiplicands to a student of claim 7, further comprising:
(a) selecting an apparatus for teaching mathematics comprising:
(i) a visual display;
(ii) rows of integers on the visual display, wherein the integers are sequentially presented from left to right and from top to bottom; and
(iii) wherein a plurality of the integers are highlighted as a pattern, said highlighted integers each having one common factor such that each highlighted integer is a multiple of the factor;
(b) selecting and adapting the apparatus such that the pattern of the highlighted integers on the apparatus corresponds to the skip count of the multiplier for a range of multiplicands for which skip counting is being taught; and
(c) visually pointing out the skip counting process on the apparatus to the student during the step of teaching the student to skip count the multiplier for a range of multiplicands within the series, said range having an upper limit which is less than the upper limit of the series of multiplicands to be taught.

10. The method for teaching multiplication of a multiplier by an upper limited series of multiplicands to a student of claim 8, further comprising:
(a) selecting an apparatus for teaching mathematics comprising:
(i) a visual display;
(ii) rows of integers on the visual display, wherein the integers are sequentially presented from left to right and from top to bottom; and
(iii) wherein a plurality of the integers are highlighted as a pattern, said highlighted integers each having one common factor such that each highlighted integer is a multiple of the factor;
(b) selecting and adapting the apparatus such that the pattern of the highlighted integers on the apparatus corresponds to the skip count of the multiplier for a range of multiplicands for which skip counting is being taught; and
(c) visually pointing out the skip counting process on the apparatus to the student during the step of teaching the student to skip count the multiplier for a range of multiplicands within the series, said range having an upper limit which is less than the upper limit of the series of multiplicands to be taught.

11. A method for teaching multiplication of a multiplicand by an upper limited series of multipliers to a student, said method comprising:
(a) determining a value of the multiplicand to be taught to the student;
(b) determining the range and the upper limit of the upper limited series of multipliers to be taught to the student;
(c) teaching the student to skip count the multiplicand for a range of multipliers within the series, said range having an upper limit which is less than the upper limit of the series of multipliers to be taught;
(d) progressively increasing said lesser upper limit of the series of multipliers for which the student is taught to skip count to the upper limit of the series of upper limited multipliers to be taught, as the student learns to skip count the multiplicand for increasing ranges of multipliers; and
(e) teaching the student a strategy for multiplication comprising determining a product by skip counting by the multiplicand for a number of iterations equal to the multiplier.

12. The method for teaching multiplication of a multiplicand by an upper limited series of multipliers to a student of claim 11, wherein the step of teaching the student to skip count the multiplicand for a range of multipliers within the series, said range having an upper limit which is less than the upper limit of the series of multipliers to be taught is comprised of a call and echo chant wherein the teacher chants the skip count for the range of multipliers and the student echoes the same chant to the teacher.

13. The method for teaching multiplication of a multiplicand by an upper limited series of multipliers to a student of claim 11, further comprising:
(a) selecting an apparatus for teaching mathematics comprising:
(i) a visual display;
(ii) rows of integers on the visual display, wherein the integers are sequentially presented from left to right and from top to bottom; and
(iii) wherein a plurality of the integers are highlighted as a pattern, said highlighted integers each having one common factor such that each highlighted integer is a multiple of the factor;
(b) selecting and adapting the apparatus such that the pattern of the highlighted integers on the apparatus corresponds to the skip count of the multiplicand for a range of multipliers for which skip counting is being taught; and
(c) visually pointing out the skip counting process on the apparatus to the student during the step of teaching the student to skip count the multiplicand for a range of multipliers within the series, said range having an upper limit which is less than the upper limit of the series of multipliers to be taught.

14. The method for teaching multiplication of a multiplicand by an upper limited series of multipliers to a student of claim 12, further comprising:
(a) selecting an apparatus for teaching mathematics comprising:
(i) a visual display;
(ii) rows of integers on the visual display, wherein the integers are sequentially presented from left to right and from top to bottom; and
(iii) wherein a plurality of the integers are highlighted as a pattern, said highlighted integers each having one common factor such that each highlighted integer is a multiple of the factor;
(b) selecting and adapting the apparatus such that the pattern of the highlighted integers on the apparatus corresponds to the skip count of the multiplicand for a range of multipliers for which skip counting is being taught; and
(c) visually pointing out the skip counting process on the apparatus to the student during the step of teaching the student to skip count the multiplicand for a range of multipliers within the series, said range having an upper limit which is less than the upper limit of the series of multipliers to be taught.

15. A method for teaching division, including a method for teaching multiplication of a first factor by an upper limited series of second factors, to a student, said method comprising:
(a) determining a value of the first factor to be taught to the student;
(b) determining the range and the upper limit of the upper limited series of second factors to be taught to the student;
(c) teaching the student to skip count the first factor for a range of second factors within the series, said range having an upper limit which is less than the upper limit of the series of second factors to be taught;
(d) progressively increasing said lesser upper limit of the series of second factors for which the student is taught to skip count to the upper limit of the series of upper limited second factors to be taught, as the student learns to skip count the first factor for increasing ranges of second factors; and
(e) teaching the student a strategy for division which uses said skip counting procedure.

16. The method for teaching division, including a method for teaching multiplication of a first factor by an upper limited series of second factors, to a student of claim 15, wherein the strategy for division comprises determining a quotient by skip counting the divisor until the dividend is reached, whereby the quotient is the number of times that the divisor has been skip counted.

17. The method for teaching division, including a method for teaching multiplication of a first factor by an upper limited series of second factors, to a student of claim 15, wherein the strategy for division comprises determining a divisor by skip counting the quotient until the dividend is reached, whereby the divisor is the number of times that the quotient has been skip counted.

18. The method for teaching division, including a method for teaching multiplication of a first factor by an upper limited series of second factors, to a student of claim 15, further comprising:
(a) selecting an apparatus for teaching mathematics comprising:
(i) a visual display;
(ii) rows of integers on the visual display, wherein the integers are sequentially presented from left to right and from top to bottom; and
(iii) wherein a plurality of the integers are highlighted as a pattern, said highlighted integers each having one common factor such that each highlighted integer is a multiple of the factor;
(b) selecting and adapting the apparatus such that the pattern of the highlighted integers on the apparatus corresponds to the skip count of the first factor for a range of second factors for which skip counting is being taught; and
(c) visually pointing out the skip counting process on the apparatus to the student during the step of teaching the student to skip count the first factor for a range of second factors within the series, said range having an upper limit which is less than the upper limit of the series of second factors to be taught.

19. The method for teaching multiplication of a multiplier by an upper limited series of multiplicands to a student of claim 9, wherein the apparatus further comprises a plurality of chips forming the highlighted pattern, each said chip being releasably attachable to the display, and each said chip having a transparent face for highlighting an integer covered by the chip.

20. The method for teaching multiplication of a multiplier by an upper limited series of multiplicands to a student of claim 9, wherein the visual display and each chip are adapted such that each chip is magnetically releasably attachable to the display.

21. The method for teaching multiplication of a multiplier by an upper limited series of multiplicands to a student of claim 9, wherein the display is a poster board and wherein the last rightmost integer of each row of integers is a multiple of 10.

22. The method for teaching multiplication of a multiplicand by an upper limited series of multipliers to a student of claim 13, wherein the apparatus further comprises a plurality of chips forming the highlighted pattern, each said chip being releasably attachable to the display, and each said chip having a transparent face for highlighting an integer covered by the chip.

23. The method for teaching multiplication of a multiplicand by an upper limited series of multipliers to a student of claim 13, wherein the visual display and each chip are adapted such that each chip is magnetically releasably attachable to the display.

24. The method for teaching multiplication of a multiplicand by an upper limited series of multipliers to a student of claim 13, wherein the display is a poster board and wherein the last rightmost integer of each row of integers is a multiple of 10.

25. The method for teaching multiplication of a multiplier by an upper limited series of multiplicands to a student of claim 9, wherein the step of teaching the student to skip count is comprised of a teaching modality using language arts, music, kinesthetic movement, chanting, rhythmic patterns, or visual number patterns to extend the teaching of skip counting through games and activities.
